(19) United States
(12) Patent Application Publication
(10) Pub. No.: US 2021/0153452 A1
(43) Pub. Date: May 27, 2021

(54) LITTER BOX CONTAINMENT SYSTEM FOR PETS

(71) Applicant: Arrival Enterprises, LLC, Bridgeton, MO (US)

(72) Inventor: Christopher J. Jeglia, Bridgeton, MO (US)

(73) Assignee: Arrival Enterprises, LLC, Bridgeton, MO (US)

(21) Appl. No.: 17/100,460

(22) Filed: Nov. 20, 2020

Related U.S. Application Data
(60) Provisional application No. 62/939,073, filed on Nov. 22, 2019.

(51) Int. Cl. A01K 1/01

(52) U.S. Cl. CPC A01K 1/0107

(57) ABSTRACT

A Litter Box Containment System for Pets has a base with sealed walls on four sides that prevents cat urine from leaking onto an adjacent floor, a lid that detaches from the base and fits beneath the base during usage, a ramp with ribbed tread surface, and a holder for accessories. The base has a planar rectangular plate with edges on its perimeter perpendicular to the plane of the plate. The interior of the base has a waterproof liner that prevents any pet urine leakage from pet usage from staining the floor below. Within the base, it stores a ramp that has a tread material on its upper surface that catches the litter from a pet's paws and an accessory holder for litter scoops. The system has an open configuration with the lid beneath the base and a closed configuration with the lid secured to the edges.

### CROSS-REFERENCE TO RELATED APPLICATION

This non-provisional application claims priority to the pending provisional application Ser. No. 62/939073 filed on Nov. 22, 2019 and all applications are owned by the same inventor.

### BACKGROUND OF THE INVENTION

The present invention relates to furniture suitable for pets in a residence. The Litter Box Containment System for Pets has particular utility in containing litter within a sealable, portable container.

Much like other animals, a cat urinates and defecates. Unlike other animals, a cat prefers a tidy place for those two tasks. When that place becomes dirty, a cat will pout or do those two tasks elsewhere. A cat outdoors has plenty of other places to choose from. A cat indoors may perform those two tasks at a less than desirable location.

Cats often prefer sandy or loose soil locations for those two tasks. Then the cat may bury or conceal the waste. Outdoor cats choose such locations readily. But a cat owner must provide a similar location for a housecat. From before the Egyptians, people have taken in cats, loved them, and made them pets. Over the centuries, owners and cats got along while owners accepted their role as staff to the cats. Owners would provide suitable housing for the cats and food from time to time.

In recent centuries, owners put cats to work ridding places of vermin. Such places included homes, barns, grain storage bins, and the like. Cats had a food source from the vermin and lived within the structures. Cats at work had an enjoyable life though perhaps a truncated one from workplace hazards, larger animals, and the like. In the last few decades, owners have eased the lives of many cats and brought them indoors to the home with limited work to do. Yet, cats still produce their waste. Owners and industry have responded with a wide variety of litter, litter boxes, and small pet houses.

Though this specification uses the word cat, the description of the invention applies to other pets and small livestock who utilize litter and to some extent woodchips. This description utilizes the words cat and pet interchangeably. Also, where a feminine pronoun is used, the masculine pronoun is implied, as cats, pets, and livestock have both genders.

### DESCRIPTION OF THE PRIOR ART

Many owners have experience litter collecting waste from cats only to find the litter making its way from a litter box to the nearby floor. A cat may kick the litter out of the litter box with her paw. A cat may carry litter on her legs and the litter falls on its own from the fur. A cat may have litter upon her paws that detaches from the paw and falls. Some litter boxes have a location on a concrete floor that withstands litter. Other litter boxes have a location on a wood floor that may collected litter in crevices. Other litter boxes have their locations on a vinyl floor that may temporarily receive litter pressed into it beneath a person's shoe. For some floors, litter may leave a permanent indentation.

From time to time, owners of cats may desire to relocate a litter box. For a short move, the owner pushed the litter box to another part of the floor in the same room. For a longer move, the risk of an owner spilling the litter increases. Doing a longer move calls for guiding the cat out of the box, cleaning the box, moving the box, and reassembling the box. Owners have enough else going on in their lives and seek to minimize work in moving a litter box.

Though preceding description has referred to residential settings, the description also applies to cats kept in light industrial and other facilities for rodent control. While the above-described devices fulfill their respective, particular objectives and requirements, the aforementioned devices do not describe a Litter Box Containment System for Pets that permits capture and retention of litter near a litter box, scratch resistance of the System to nearby floor, covering of a litter box for transport, and a handle for carrying the System from one location to another. Therefore, a need exists for new and improved Litter Box Containment System for Pets that can be used for capturing litter and then moving the litter box. In this regard, the present invention substantially fulfills this need. In this respect, the Litter Box Containment System for Pets according to the present invention substantially departs from the conventional concepts and designs of the prior art, and in doing so provides a device primarily developed for the purpose of capturing litter, moving a litter box, and avoiding scratching of floors in a home, an office, a light industrial setting, and the like.

The Litter Box Containment System for Pets overcomes the above-mentioned disadvantages and drawbacks of the prior art. As such, the general purpose of the present invention, which will be described subsequently in greater detail, is to provide a new and improved Litter Box Containment System for Pets which has all the advantages of the prior art mentioned heretofore and many novel features that result in Litter Box Containment System for Pets which are not anticipated, rendered obvious, suggested, or even implied by the prior art, either alone or in any combination thereof.

### SUMMARY OF THE INVENTION

The Litter Box Containment System for Pets, or the Victoria Litter Box Pet Tray®, has a base with sealed walls on four sides that prevents cat urine from leaking onto an adjacent floor, a lid that detaches from the base and fits under the base during usage, a ramp with ribbed tread surface, and a holder for accessories. The Litter Box Containment System for Pets begins with a base unit made of a planar rectangular sheet that has edging on all four side of the base unit. The interior of the base unit has a water impervious liner, a sheet, a layer, or a cover of a waterproof material that prevents any urine leaking that may occur during pet box usage from staining the floor. Within the base unit, the invention stores a pet ramp that has a tread material on its upper surface that catches the pet litter from a pet's paws and that has an accessory holder for pet litter scoops.

This invention receives most sizes of pet boxes and has additional storage behind the box for extra items, such as a brush and a dust pan to use for keeping the tray clean. To describe usage of the invention, a pet walks up to the Litter Box Containment System for Pets and steps over the side of the tray and walks up the ramp, which has a slight incline, and enters the pet box, and then uses the litter in the box. The pet then exits the pet box and walks down the ramp while the tread on the pet ramp removes most of the litter that has accumulated on the pet's paws. Any litter knocked out of the pet box during usage collects with the base unit of the invention.

The Litter Box Containment System for Pets is a self-contained unit with a removable lid attached with screws and a handle for easy carrying. The screws are removed and stored by the owner and the lid is attached to the base of the unit with Velcro®, or a Velcro-like material when the unit is in use. When the pet owner is ready to move to a new residence, the owner reattaches the lid with screws and the pet owner takes the Litter Box Containment System for Pets to a new location using the handle.

There has thus been outlined, rather broadly, the more important features of the invention in order that the detailed description thereof that follows may be better understood and in order that the present contribution to the art may be better appreciated.

The Litter Box Containment System for Pets also keeps the room where unit is in use and the rest of the house free of most of the pet litter from the pet box that a pet's paws transfer out of the pet box following the pet's usage of the box. This saves the homeowner time and stress from cleaning pet litter from around the house that has escaped from the pet box during usage.

This invention also has a waterproof surface on the inside of the tray for easy cleanup of pet urine, a pet ramp that catches the pet litter that accumulates on the pet's paws, and an accessory holder for litter scoops. This invention also prevents the floor of the room of its usage from retaining stains of pet urine or pet litter indentations on wood floors. Additional features of the invention will be described hereinafter and which will form the subject matter of the claims attached.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. In this respect, before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and devices for carrying out the several purposes of the present invention. It is important, therefore, that the claims be regarded as including such equivalent constructions insofar as they do not depart from the spirit and the scope of the present invention.

It is therefore an object of the present invention to provide a new and improved Litter Box Containment System for Pets that may be easily and efficiently manufactured and marketed to the consuming public.

Still another object of the present invention is to provide a Litter Box Containment System for Pets having a self-contained unit with a removable lid attached with screws and a handle. A pet owner may remove the screws and store them and the lid attaches to the base of the unit with Velcro®, or other hook and loop fasteners during usage.

Still another object of the present invention is to provide a Litter Box Containment System for Pets that moves readily to a new residence as the pet owner reattaches the lid with the screws and then carries the invention to a new location using the handle.

Still another object of the present invention is to provide a Litter Box Containment System for Pets that lessens the burdens and hassles upon a pet owner.

Still another object of the present invention is to provide a Litter Box Containment System for Pets that retains litter placed within it.

Still another object of the present invention is to provide a Litter Box Containment System for Pets that provides a pet ramp with a tread top and a built in accessory holder for pet litter scoops and has a shape for storage of the pet ramp within the unit.

Still another object of the present invention is to provide a Litter Box Containment System for Pets that will fit most size pet boxes and includes additional storage behind the box for extra items, such as a brush and a dust pan for keeping the tray clean.

Still another object of the present invention is to provide a Litter Box Containment System for Pets that occupies a minimum of surface area in a home, thus saving space for a pet owner.

Still another object of the present invention is to provide a Litter Box Containment System for Pets that minimizes tipping of the invention during usage.

Still another object of the present invention is to provide a Litter Box Containment System for Pets that avoids scratching a supporting surface, such as a floor.

Still another object of the present invention is to provide a Litter Box Containment System for Pets that avoids staining a floor and prevents indentations in flooring from an owner stepping upon litter.

Still another object of the present invention is to provide a Litter Box Containment System for Pets that fits through a residential doorway.

Still another object of the present invention is to provide a Litter Box Containment System for Pets that has a lid attaching to its base with removable and reusable mechanical fasteners.

Still another object of the present invention is to provide a Litter Box Containment System for Pets that has a lid has at least one strip of hook and loop fastener upon its exterior surface and a layer of non-marring, or felt like, material upon its opposite interior surface.

Still another object of the present invention is to provide a Litter Box Containment System for Pets that has a lid that detaches from the top of the unit and reattaches to the base of the system becoming the bottom of the invention during its usage.

Still another object of the present invention is to provide a Litter Box Containment System for Pets that has a lid with its felt like material presented to a supporting floor surface to avoid scratching the floor and preventing pet urine and pet related debris from contacting the floor.

Still another object of the present invention is to provide a Litter Box Containment System for Pets that has a permanently attached handle for ready movement of the invention.

Still another object of the present invention is to provide a Litter Box Containment System for Pets that has a sturdy, lightweight construction that resists staining and liquid absorption.

Still another object of the present invention is to provide a Litter Box Containment System for Pets that provides for ready cleaning of the interior and the exterior of the invention and shows no damage to the invention from any liquid left upon it.

Still another object of the present invention is to provide a Litter Box Containment System for Pets that avoids retention of odors from liquids deposited in the invention by pets.

Still another object of the present invention is to provide a Litter Box Containment System for Pets that provides an adjustable pet ramp with a ribbed polymer surface for tread, that has its location near the front of the invention, and the ribbed surface captures litter transferred from a pet's paws.

Still another object of the present invention is to provide a Litter Box Containment System for Pets that keeps the nearby area of the invention free from cat litter transferred out of a litter box on the paws of the cat or other household pet.

Still another object of the present invention is to provide a Litter Box Containment System for Pets that holds at least one existing pet litter box within it and that readily places upon a floor accessible by household pets.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

In referring to the drawings,

FIG. 1 is a perspective view of the preferred embodiment of the present invention;

FIG. 2 is a perspective view of the invention when closed;

FIG. 3 shows an exploded view of the invention;

FIG. 4 illustrates a top view of the invention when closed;

FIG. 5 shows a bottom view of the invention when open;

FIG. 6 is a side view of the invention;

FIG. 7 is a side view of the invention opposite that of FIG. 6;

FIG. 8 is a rear view of the invention;

FIG. 9 is a front view of the invention;

FIG. 10 is a top view of the base;

FIG. 11 is a sectional view of the base;

FIG. 12 is a section view of the base perpendicular to FIG. 11;

FIG. 13 is a top view of the lid;

FIG. 14 is a bottom view of the lid;

FIG. 15 is a front view of the lid;

FIG. 16 is a rear view of the lid;

FIG. 17 is a side view of the lid;

FIG. 18 is a side view of the lid opposite FIG. 17; and,

FIG. 19 is a perspective view of an alternate embodiment of the invention.

The same reference numerals refer to the same parts throughout the various figures.

### DESCRIPTION OF THE PREFERRED EMBODIMENT

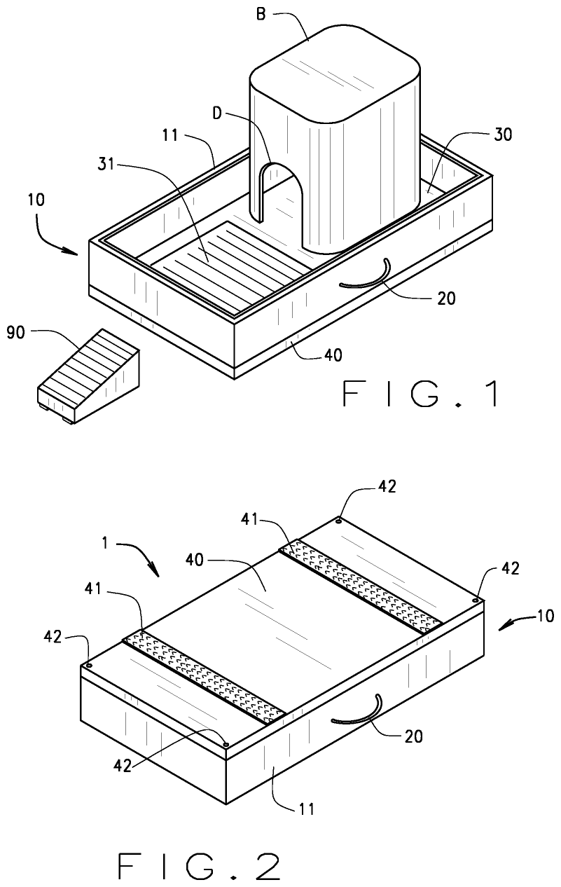

Referring now to the drawings, and particularly to FIGS. 1-19, a preferred embodiment of the Litter Box Containment System for Pets of the present invention is shown by the reference numeral 1. The Litter Box Containment System for Pets also goes by the name of Victoria Litter Box Pet Tray®. The Litter Box Containment System for Pets is desirable for keeping the pet litter from inside the pet box from going out into the room and thus, into the rest of the house after the pet has used the pet box. The present invention relates to furniture suitable for pets in a residence. The Litter Box Containment System for Pets has particular utility in keeping the pet litter from inside the pet box from going out into the room and thus, away from to the rest of the house after the pet has used the pet box. This system also keeps the floor of the room where it is in use from pet urine staining and from pet litter indentations.

This invention keeps the room where unit is in use and the rest if the house free of most of the pet littler from inside the pet box that gets transferred out of the pet box on the pets' paws after the pet has used the box. This saves the homeowner time and stress from cleaning up pet litter around the house that has gotten out of the pet box during usage.

In FIG. 1, the present invention 1 has a generally rectangular form shown as a perspective view of the preferred embodiment in an open configuration. The open configuration, or position, allows a cat to enter the invention. The invention 1 admits an existing litter box B, or a pet house, within it as shown that has a door D, or entry. The litter box fits within the base 10 here having a hollow rectangular form with a perimeter and upright edges, as at 11, upon the perimeter of the base, more particularly its base, as later described. One edge has a handle 20 generally centered and denoting the right of the invention as seen by a cat.

The base and the edges have a waterproof layer, as at 30, upon their interior surfaces for easy cleaning of pet urine. The base also has a tread layer 31 here shown ahead of the litter box B. The tread layer occupies less than half of the length and width of the base. The tread layer has a rug like texture that engages the fur of the cat to dislodge litter upon it. Then beneath the base 10, the invention has its lid 40 that spans beneath the entire footprint of the base. The lid does not scratch or mar any floor beneath it.

Outwardly from the base in this figure, the invention 1 also has a ramp 90 that catches some of the pet litter that accumulates on the pet's paws after use of the pet box and an accessory holder—not shown—for litter scoops. The ramp has a base with a non-marring surface and a perimeter, four edges upon the perimeter with two edges being mutually parallel and of trapezoidal shape, a handle upon one trapezoidal shaped edge, and a scratch surface, as at 31 spanning between the four edges and above the base. The ramp has a size to fit within the base 10 and a height comparable to that of a lateral edge. The pet ramp may have two handles 20 on either trapezoidal edge for easy pickup to clean the unit. A tread material 31, with ribs, covers the top of the ramp 90. Opposite the tread material, the ramp has its strip of releasable fastener.

Before the invention appears as in FIG. 1, the pet owner carries it to a location. A pet owner does so with the invention in its closed configuration shown in FIG. 2 as a perspective view. The invention has its base 10 with edges 11 and handle 20 as before. The invention has four edges that receive the lid 40 above the plate. The lid has a generally planar rectangular form, a thickness, a length, and a width where the length and the width fit across a thickness of the edges 11. The lid has Velcro®, other hook and loop like material, or releasable strip of fastener that connects it to the base opposite the edges during usage. In a further alternate embodiment, two edges of the base have hook and loop materials that retain the pet ramp and the accessory holder in position during use. Typically, the holder has its location upon a longitudinal edge. The lid fits upon the base, more particularly the upright edges 11, in the closed configuration and has mechanical fasteners securing it to the edges.

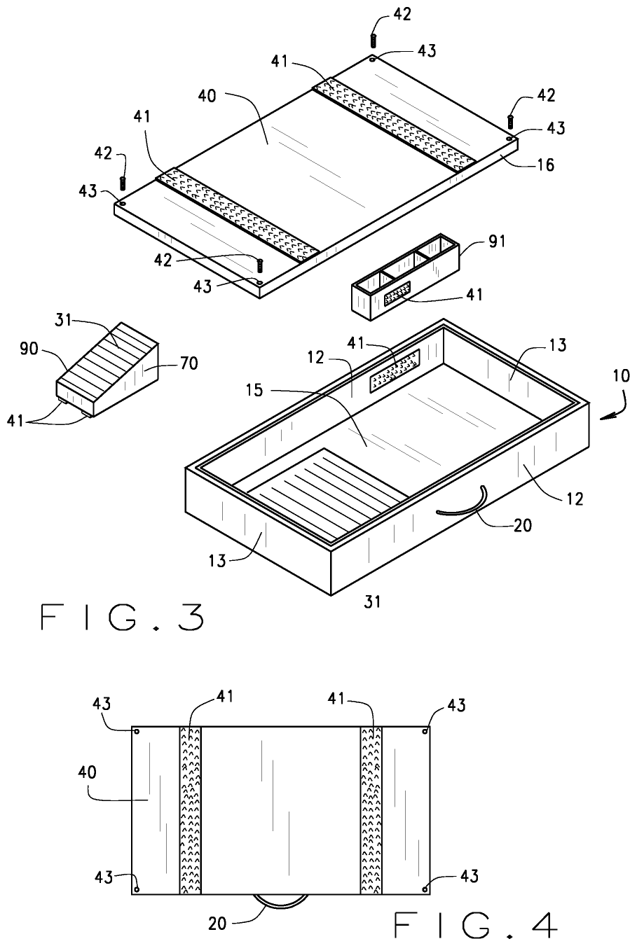

The lid has at least one strip 41 of releasable fastener, such as hook and loop material, that extends transverse, that is, perpendicular to the length of the lid. The at least one strip 41 has a position upon the top of the lid as shown, that is opposite a non-marring layer later shown and described. The at least one strip appears outwardly when the invention has its closed configuration, here shown in FIG. 2. The counterpart of the Velcro®, hook and loop like material, or other releasable fastener, of the strip 41, has its position on the bottom of the base as later shown in FIG. 4. The at least one strip 41 has a width of about ½ inch and a length of at least six inches.

The lid 40 attaches to the edges 11 of the base 10 by at least four mechanical fasteners 42, such as screws or a two-part fastener. The at least four screws provide removable and reusable mechanical fastening for when the unit is in storage, in transit, or in a retail store. Opposite the strip 41, the lid has its bottom surface, not shown, that when placed under the base 10 presents its bottom surface, that is, a full sheet of felt to prevent scratching a floor or a supporting surface. The lid removes from the edging 11 and attaches to the bottom of the base unit during usage. The lid has its bottom surface towards a floor or supporting surface thus preventing the invention from scratching a floor during usage. The base unit and corresponding lid of the Litter Box Containment System for Pets may have a size as small as 2 feet by 4 feet to contain one pet box or as large as 4 feet by 8 feet to contain 2 or 3 pet boxes.

FIG. 3 shows an exploded view of the invention 1 with its base 10 towards the bottom of the figure. The base has its generally rectangular form as shown with a rectangular liner 15 upon its interior and a perimeter. Outwardly from the water impervious liner and perpendicular to the plane of the liner, the base 10 has two mutually parallel and spaced apart longitudinal edges 12 and two mutually parallel and spaced apart lateral edges 13 perpendicular to the longitudinal edges. The longitudinal edges 12 and the lateral edges 13 form a fence around the liner 15 of the base 10 as shown. The four edge 12, 13 capture litter and contain a litter box placed within them. Towards the front of the invention, that is, lower right of the figure, the base has its handle 20 centered upon a longitudinal edge. The handle may extend outwardly for grasping by a user, or alternatively include indentations, finger holes, a grip, and the like for aiding a user to lift the invention and then carry it from one location to another. Opposite the longitudinal edge with the handle 20, the other longitudinal edge has a strip 41 of hook and loop fastener towards one lateral edge to the right of the figure. This strip near the upper right corner of the base 10 as shown receives a mating portion 41 of similar fastener upon a holder 91. The holder has a prismatic rectangular form of markedly less length and less width than that of the base 10 as shown. The holder has divided compartments for receiving tools, brushes, and other items related to the care, operation, and maintenance of a litter box.

Opposite the holder in FIG. 3, the base has its ramp 20 nearby. The ramp has its truncated sloped shape as described above and a handle 20 upon one or both trapezoidal sides as shown. Upon its slope, the ramp has a tread material adhered or attached to at a minimum a portion of the ramp. Opposite the tread material 31, the ramp has at least one strip of hook and loop material, not shown. In this figure, above the base unit, its ramp, and the holder, the invention has the lid 14 of a thin, rigid, planar, rectangular, shape as shown. The lid has its thickness, a width many times greater than the thickness, and its length greater than its width. The lid has dimensions that correspond to the longitudinal edges 12 and lateral edges 13 so that the lid fits flush upon them. The lid has four corners as shown and an aperture 43 proximate to each corner, preferably the apertures have countersinks. Each aperture receives a mechanical fastener, here shown as a screw 42, the connects the lid 14 to the base 12 when in its closed configuration. Though the description has referred to one fastener at each aperture, the Applicant foresee additional numbers and positions of fasteners and apertures that connect the lid to the base. Inwardly from the apertures, the lid has at least one strip 41 of hook and loop materials extending across its width. The at least one strip 41 cooperates with a mating at least one strip beneath the base as later shown. Opposite the strip 41, the lid has a non-marring layer 16, typically felt, soft fiber, loop material, and nylon though other materials are foreseen. The non-marring layer adheres to the entire lid.

FIG. 4 then illustrates a top view of the invention 1 in the closed configuration with the lid 14 in the foreground and upon the base 10. The lid has its rectangular shape as before that fits upon the longitudinal edges 12 and the lateral edges 13 of the base. The lid has at least one strip 41 of hook and loop material and here the figure shows two mutually parallel and spaced apart strips. These strips cooperate with counterparts beneath the base, not shown. Proximate each corner, the lid has a screw 42 into each aperture 43. Towards the bottom of this figure, the invention has its handle 20 extending beneath and outwardly from the lid. A pet owner sees the view of this figure just before lifting the invention from a floor or other supporting surface.

FIG. 5 shows a bottom view of the invention when in the open configuration previously shown in FIG. 1. The open configuration has the lid placed beneath the base flush with the plate and with the non-marring layer outward or away from the base, that is, towards a floor or other supporting surface. This view has the lid in the foreground with its non-marring layer 16 visible. The non-marring layer extends upon the entire bottom surface of the lid. Proximate each corner, the lid has a screw 42 into each aperture 43. Towards the bottom of this figure, the invention has its handle 20 extending beneath and outwardly from the lid. A pet owner sees the view of this figure just before placing the invention upon a floor or other supporting surface.

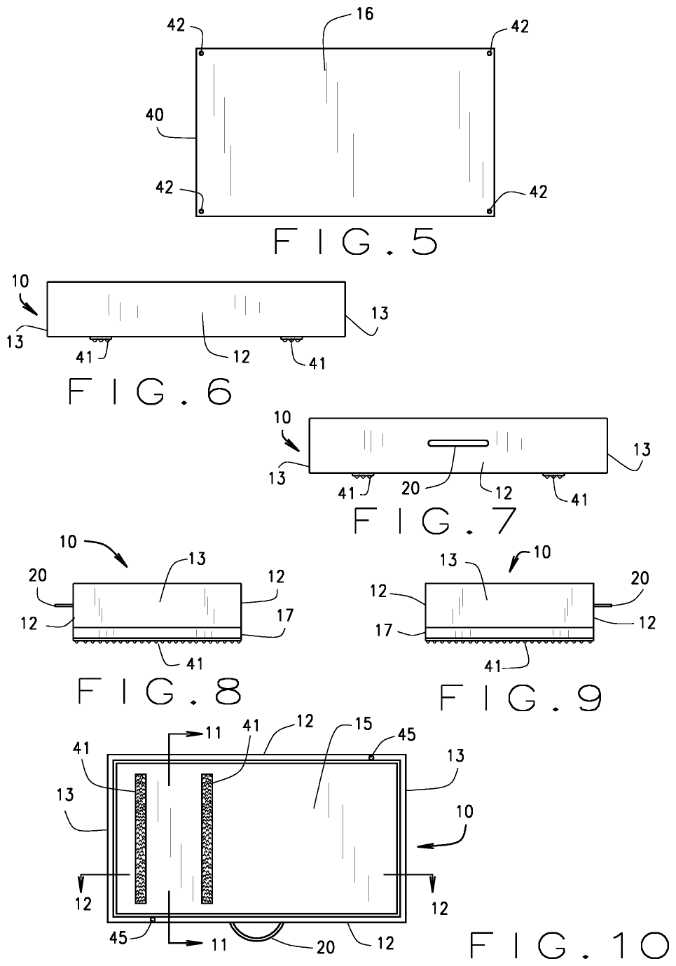

FIG. 6 is a side view of the invention, particularly the base 10. This view has a longitudinal edge 12 in the foreground. The longitudinal edge has its length that defines the length of the invention and its height perpendicular to its length that also defines the height of the invention. Its height is less than its length and of an amount suitable to retain litter within the invention but not so much that it prevents a cat or a pet from climbing over it. The longitudinal edge has two ends that join to the lateral edges 13 here shown apart. Beneath the longitudinal edge, the base has the ends of two strips 41 of releasable fastener shown that cooperate, or engage, with similar strips upon the lid as previously shown and described. The two strips attach to a plate 17 of rectangular form that defines the lowest portion of the base 10.

Turning to FIG. 7, this figure shows a side view of the invention opposite that of FIG. 6. FIG. 7 has the other longitudinal edge 12 that has the handle 20 upon it.

FIG. 8 is a rear view of the invention generally behind any litter box or cat house placed into the invention as in FIG. 1, that is opposite the ramp 90. This view shows a lateral edge 13 upon the plate 17 and perpendicular to the longitudinal edges. Below the plate, the invention has a strip 41 of hook and loop material ready to engage with the counterpart strip of releasable fastener upon the lid.

FIG. 9 is a front view of the invention opposite that of FIG. 8 and it has the handle 20 shown to the right. This view shows the other lateral edge 13 mutually parallel and spaced apart from that of FIG. 8. The handle here to the right follows the invention shown in FIG. 1, that is, as a cat or a pet would enter the invention from the ramp. Beneath the lateral edge, the base 10 has a strip 41 of releasable fastener as before.

FIG. 10 is a top view of the base 10 of the invention showing its rectangular form and interior sheet 15. This view is opposite that of FIG. 5. The interior sheet 15 provides water and urine proofing to the base and attaches to the plate 17. The plate also has the longitudinal edges 12 and the lateral edges 13 attached, or secured, upon its perimeter. The four edges cooperate to retain litter within the base 10 during usage of the invention. One longitudinal edge 12 has the handle 20 showing, here downwardly in the figure.

Further, the base includes two alignment bosses 45 that assist a user to align the lid when putting the invention into the closed configuration. The bosses fit into cooperating depressions in the lid as later shown in FIGS. 15-18. Here, the base has its alignment bosses on the longitudinal edges 12 generally opposite the plate 17 and the bosses extend perpendicular to the plane of the longitudinal edges. The two bosses have locations diagonally opposite as shown, slightly inward from corners. A user may put one boss 45 into a depression, later shown, rotate the lid 40 so it fits upon the four edges, and then secure the lid to the base using the screws 42 as previously described.

FIG. 11 is a sectional view of the base generally parallel to a lateral edge. This view shows the plate 17 generally thin and extending across the width of the base and a strip 41 shown by its length. Opposite the strip, the plate has the two longitudinal edges 12 extending perpendicular to the plate and mutually parallel and spaced apart to each other. Each longitudinal edge shows one boss 45 shown upwardly from the plane of the section. The bosses have a generally rounded form that cooperates with depressions in registration, later shown. The plate has the sheet 15 upon it opposite the strip, that is, in the interior of the base. The longitudinal edges also have portions of sheet 15 upon them, generally denoting their interior faces. As before, the sheet provides water and urine proofing to the base. The longitudinal edges join to the plate at its perimeter using adhesive and mechanical fasteners such as nails. At the tight joint of the longitudinal edges to the plate, the invention has a bead of caulk at 46 upon the interior of the joint, that is, toward the interior of the base, and beneath the sheet 15.

FIG. 12 is a section view of the base perpendicular to FIG. 11. This view of the base appears generally parallel to a longitudinal edge 12. The longitudinal edge shown has its boss 45 here extending upwardly, that is opposite the plate 17. This view shows the plate 17 generally thin and extending across the length of the base and two strips 41 shown on their ends. Opposite the two strips, the plate has the two lateral edges 13 extending perpendicular to the plate and mutually parallel and spaced apart to each other. The plate has the sheet 15 upon it opposite the strips as above upon the interior of the base. The lateral edges also have portions of sheet 15 upon them, generally denoting their interior faces. The sheet and portions of sheet cooperate to provide water and urine proofing to the base. Portions of the sheet join to the sheet in a sealed connection. The sealed connection begins where the lateral edges 13 join to the plate 17 at its perimeter using adhesive and mechanical fasteners such as nails. At the tight joint of the lateral edges to the plate, the invention again has a bead of caulk at 46 upon the interior of the joint, that is, toward the interior of the base, and beneath the sheet 15.

Turning to the lid itself, FIG. 13 shows it in a top view. The lid 40 has its rectangular shape that fits upon the edges 12, 13 of the base 10 as previously shown and described. The lid has its top surface 40a here shown in the foreground. The top surface appears visible when the invention is in its closed configuration as previously shown in FIG. 2, that is, the top surface is outwardly or away from the edges 11. Preferably the lid has a flush orientation to the upright edges 11. The upright edges 11 have a mutual perpendicular orientation to the plate. Then the upright edges include lateral edges and longitudinal edges. The top surface has at least one strip of releasable fastener as at 41 upon it, here the figure shows two strips mutually parallel and parallel to a lateral edge 12 of the base when installed. That is the strips have a shorter length than the length of the lid. Proximate each corner of the lid, it has an aperture 43 that receives a mechanical fastener 42 as previously shown and described.

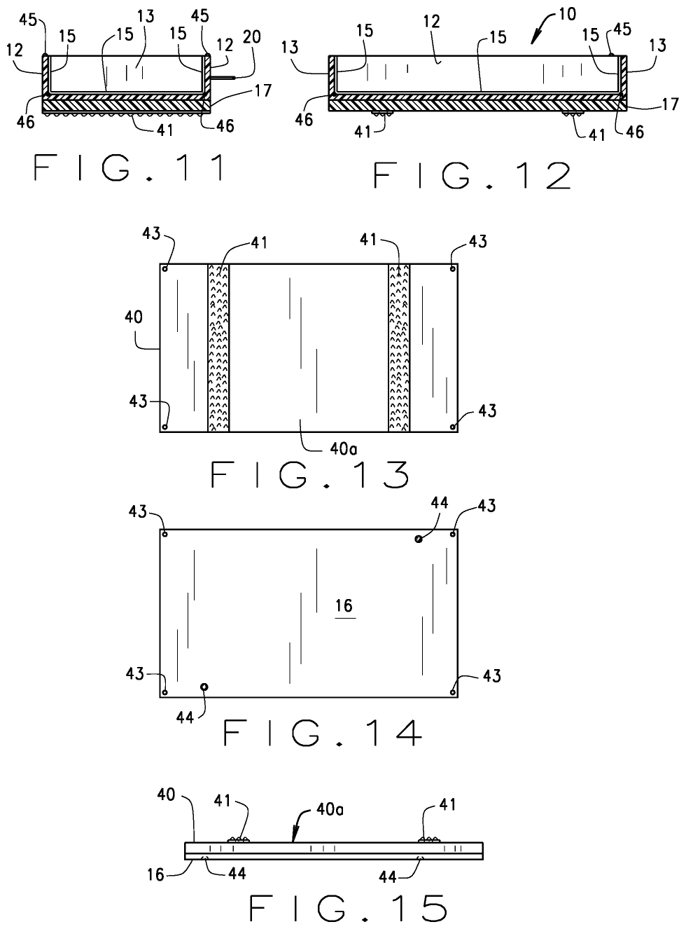

FIG. 14 then has a bottom view of the lid 40 opposite that shown in FIG. 13. Opposite it top surface 40a, the lid 40 has its non-marring layer 16, typically felt, though other materials may be used in the invention. The non-marring layer adheres to the entire lid. The non-marring layer has its own thickness that accommodates the heads of the mechanical fasteners 42 so that the heads do not abut the supporting surface. In an alternate embodiment, the apertures 43 shown in this view have countersink that admits a head of the mechanical fastener so it is flush with the lid. The lid also has two alignment depressions 44, extending into perpendicularly into the plane of the non-marring layer 16. The two depressions 44 have mutually diagonally opposite locations as shown. The depressions 44 receive the cooperating bosses 45, in registration, previously shown in FIGS. 10-12 upon the longitudinal edges. The depressions received the bosses in coordination when a user places or rotates the lid upon the longitudinal edges and the lateral edges so the invention attains its closed configuration.

FIG. 15 describes a side view of the lid 40 that corresponds with the view of FIG. 6. The side view is as a pet owner would see the lid. In this view, the lid 40 has the non-marring layer 16 below and the at least one strip 41, here shown as two strips, opposite the non-marring layer. The two strips shown appear with their ends visible, that is, the shortest portion of the strip. The lid has its two depressions 44 recessed into the non-marring layer. The depressions 44 have a location outwardly from the strips 41 shown. One depression is towards the foreground and the other depression is towards the background. When a user moves the Victoria Litter Box Pet Tray® to a new place, the alignment depressions 44 and corresponding bosses 45 line up vertically with each other to assist the pet owner to correctly place the lid upon the base of the invention for better alignment when installing the screws 42 as the invention attains its closed position. The alignment depressions 44 have their locations from the lid for precise alignment with the bosses 45 on the top of the longitudinal edges 12 of the Victoria Litter Box Pet Tray® for exact placement of the lid upon the base when a user moves the invention.

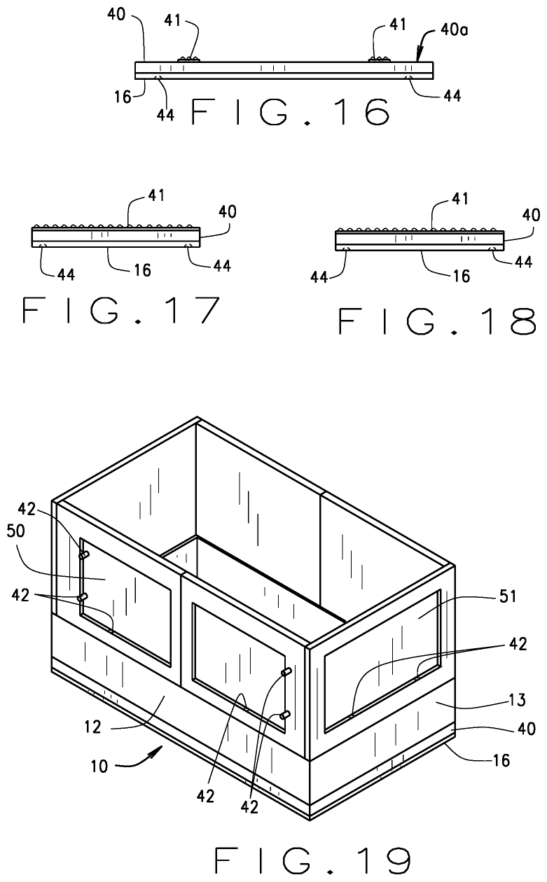

FIG. 16 describes an opposite side view of the lid 40 from FIG. 15. This view corresponds with that of FIG. 7 and a pet owner would see it when utilizing the handle. The lid also has its two alignment depressions 44 into the non-marring layer with locations outwardly from the strips 41 shown. One depression is towards the foreground and the other depression is towards the background, opposite that of FIG. 15.

FIG. 17 presents a rear view of the lid 40 generally from behind the litter box previously shown in FIG. 1. The lid 40 has the at least one strip 41 here shown lengthwise and spanning across the lid. Opposite the at least one strip 41, the lid 40 has its non-marring layer 16, also spanning across the lid. Beneath the non-marring layer, the lid also has its two alignment depressions 44 here shown to the left and the right which corresponds to the foreground and the background respectively of FIG. 15. The two depressions have diagonally opposite locations upon the lid as previously described.

FIG. 18 has a front view of the lid opposite that of FIG. 17 and generally from ahead of the litter box shown in FIG. 1 and as a cat would see the lid when deployed under the base 10 just ahead of the ramp. The lid 40 has the at least one strip 41 here shown lengthwise and spanning across the lid. The non-marring layer 16 has its position opposite the strip 40 and it also spans across the lid. The lid also has its two alignment depressions 44 in opposite locations from FIG. 17 that though correspond to the foreground and the background respectively of FIG. 15. The two depressions still have diagonally opposite locations upon the lid as previously described.

And, FIG. 19 is a perspective view of an alternate embodiment of the invention. The invention has its base 10 as before with the lid 40 located beneath it and the non-marring layer 16 at the lowest portion of the invention, towards the bottom of the figure. The base has its longitudinal edges 12 and lateral edges 13 as described above. The edges 12, 13 has a generally elongated rectangular from with a portion of liner 15 upon their interior faces, not shown. Each edge has an upright orientation and occupies minimal area upon the plate 17. The alternate embodiment has a longitudinal edge extender 50 and two corresponding lateral edge extenders 51. These three extenders 50, 51, have combined lengths to fit upon the longitudinal edge 12 and the lateral edge 13 respectively. The two extenders also have the same thickness as the edges 12, 13 and have a portion of liner 15 denoting their interior faces that aligns with the similar portions of liner 15 upon the interior of the edges. These extenders 50, 51 are also components of the Victoria Pet Tray Edge Extender.

To support the portions of liner upon the extenders 50, 51, the extenders have a frame like construction. Each extender has two mutually parallel and spaced apart uprights and two mutually parallel and spaced apart spanners perpendicular to the uprights. The two uprights and two spanners form a hollow rectangular frame where the spanners abut the edges 12, 13. Inwardly from the uprights and spanners, the extenders have a rigid panel that extends over the uprights and spanners thus covering the entire frame. Upon the rigid panel and opposite the frame, each extender has its portion of liner 15. The liner portion of each extender has a flush position with the portion of liner of the edge beneath. The flush position of the extender on its corresponding edge prevents litter and other materials from catching and accumulating on a ledge. One spanner has at least two apertures extending through it on axes parallel to the plane of the extender's portion of liner. The at least two apertures receive mechanical fasteners that secure the edge extender to its corresponding edge. The hollow frame of the extender permits a pet owner to use a screwdriver or other tool to connect and to remove an edge extender from its edge. The extenders have a releasable mechanical connection to their corresponding edges. The extenders have a coplanar orientation to their corresponding edges also. At a corner, one longitudinal edge extender has a mechanical connection to the adjacent lateral edge extender.

Generally, the alternate embodiment has an edge extender on at least one edge that extends the height of the base by at least one inch and matches the width of the edge as described above. Additional pieces of edge extender also connect to an adjacent edge extender using a mechanical fastener, or alternatively a tongue and groove connection. The edge extenders have the same construction as the other edges of the invention. The edge extenders prevent pet urine, pet litter, or pet litter dust from falling behind it and thus more of that area behind the edge extender and its edge below stays clean compared to an edge alone.

The Litter Box Containment System for Pets may have wood, plastic, PVC or a composite material. One handle may have a location on either the left or right side, of the invention on a longitudinal edge, in the center for easy carrying or movement of the invention. The pet ramp may have two handles on either side for easy pickup to clean the unit. A tread material, with ribs, covers the top of the pet ramp and a felt material covers the bottom surface of the top cover to prevent scratching a floor or other supporting surface during usage of the invention. The ribs also catch some of the litter carried out of a litter box on a pet's paws. Also, a waterproof material, liner 15, covers the entire interior of the base 10 and its edges 12, 13. In an alternate embodiment, the base, the pet ramp, and the scoop holder could also be manufactured from a single piece of material. In a further alternate embodiment, the base, the longitudinal edges, and the lateral edges are formed from a single piece of material and corners between the base, the longitudinal edges, and the lateral edges extend continuously.

The edges 12, 13 on the base 10 may have any size or height so long as the pet can step over and into the tray to use the invention. The edges have a permanent attachment to the planar plate 17 of the base 10 and have a sufficiently strong connection to the plate to support the weight of an adult person standing on it, approximately 280 lbs. Further, the pet ramp also supports the weight of an adult person. This feature provides a safeguard for when a person does not want to remove the pet ramp when cleaning out the pet box. The present invention in its preferred and alternate embodiments stands ready to serve pets of all kinds, particularly cats, and their owners in various room types and buildings.

While a preferred embodiment of the Litter Box Containment System for Pets has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, any suitable sturdy material such as plastic, polymer, metal, composite, pine for the planar plate and edging of the base and the lid or another variety of wood may be used instead of the wooden components described. The invention has a construction of a sturdy, lightweight material that resists pet urine stains and resists absorption of such fluids thus making cleaning of pet urine and fluids easy upon the interior and the exterior of the invention. Pet urine resistance becomes a key feature of the invention's construction because if pet urine encounters delay in its cleanup or the pet urine remains within the invention for an extended period of time, the invention suffers no damages and does not retain odors following a later cleaning.

Using the invention, a cat, perhaps named Victoria or Tiffany or Dixie, will have no problem stepping over the edging of the base unit and into the base then proceeding up the ramp to use the pet box. This invention could also be used by perhaps small dogs, rabbits or any other house pets that are trained to use pet litter and are large enough to step over the edges and proceed up the pet ramp to the pet box.

Although providing a place that contains litter has been described, it should be appreciated that the Litter Box Containment System for Pets herein described is also suitable for apartments, condominiums, dormitory rooms, houses, offices, light industrial facilities, warehouses, garages, motor pools, select mines, and the like where a pet, such as a cat, can find a home.

The Applicant reminds the reader that the invention is not a toy. The edges and edge extenders of the base of the Litter Box Containment System for Pets pose a trip hazard and extreme care must be taken when near the invention or when cleaning a pet box or the unit itself. The present invention may have its edges rounded over or sanded smooth, painting in a variety of colors, and application of additional mechanical fasteners where suitable.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Various aspects of the illustrative embodiments have been described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations have been set forth in order to provide a thorough understanding of the illustrative embodiments. However, it will be apparent to one skilled in the art that the present invention may be practiced without the specific details. In other instances, well known features are omitted or simplified in order not to obscure the illustrative embodiments.

Various operations have been described as multiple discrete operations, in a manner that is most helpful in understanding the present invention, however, the order of description should not be construed as to imply that these operations are necessarily order dependent. In particular, these operations need not be performed in the order of presentation.

Moreover, in the specification and the following claims, the terms “first,” “second,” “third” and the like—when they appear—are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to ascertain the nature of the technical disclosure. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

I claim:

1. A furniture device for containing litter, comprising:
a base, generally rectangular, having a plate and four spaced apart upright edges upon said plate, a water impervious liner interiorly of said upright edges and said plate, a tread material upon a portion of said liner, and at least one strip of releasable fastener upon said plate opposite said edges;
a lid, generally a planar rectangle, said lid fitting upon said four upright edges, said lid having a top surface and an opposite non-marring layer, and at least one strip of releasable fastener upon said top surface;
wherein said device has an open configuration with said lid positioned beneath said base flush with said plate and said at least one strip of releasable fastener of said top surface engaging said at least one strip of releasable fastener of said base and said non-marring layer positioned away from said base; and,
wherein said device has a closed configuration with said lid secured to said edges with mechanical fasteners, said top surface of said lid being outwardly from said edges, and said lid being flush with said upright edges.

2. The furniture device of claim 1 further comprising:
said plate having a perimeter and said edges securing to that perimeter;
said upright edges being mutually perpendicular to said plate, said upright edges including two mutually parallel and spaced apart lateral edges and two mutually parallel and spaced apart longitudinal edges, said longitudinal edges being perpendicular to said lateral edges;
a handle extending outwardly from one of said longitudinal edges;
a holder releasably connecting to one of said longitudinal edges, said holder adapted to receive hand tools and supplies for pet care;
a ramp having its height proportional to that of a lateral edge, a portion of tread material, and at least one strip of releasable fastener opposite the tread material.

3. The furniture device of claim 1 further comprising:
said plate having a perimeter and said upright edges securing to that perimeter;
said upright edges including two mutually parallel and spaced apart lateral edges and two mutually parallel and spaced apart longitudinal edges, said longitudinal edges being perpendicular to said lateral edges;
said lid fitting upon said lateral edges and said longitudinal edges opposite said plate when in said closed configuration; and,
said lid having four corners and at least one aperture proximate each corner, at least one mechanical fastener for each of said at least one aperture, and two strips of releasable fastener upon said top surface, said strips being mutually parallel and spaced apart.

4. The furniture device of claim 2 further comprising:
at least one lateral edge extender and at least one longitudinal edge extender;
said at least one lateral edge extender having a releasable mechanical connection to one of said lateral edges opposite said plate and said at least one lateral edge extender being coplanar with said lateral edge;
said at least one longitudinal edge extender having a releasable mechanical connection to one of said longitudinal edges opposite said plate and said at least one longitudinal edge extender being coplanar with said longitudinal edge;
wherein a longitudinal edge extender mechanically connects to an adjacent lateral edge extender; and,
wherein said at least one lateral edge extender and said at least one longitudinal edge extender cooperate with said base to increase litter retained within said base.

5. The furniture device of claim 3 further comprising:
at least one boss upon at least one of said longitudinal edges;
at least one depression extending perpendicularly into said non-marring layer;
wherein said at least one boss aligns and enters said at least one first depression when said device attains the closed configuration; and,
wherein said at least one strip of releasable fastener of said lid cooperates with said at least one strip of releasable fastener of said plate when said device attains the open configuration.

6. The furniture device of claim 5 further comprising:
each of said longitudinal edges having one of said depressions, said depressions locating mutually diagonally; and,
two of said bosses also locating mutually diagonally wherein said lid cooperates with said upright edges as said bosses align with said depressions as said device attains the closed configuration.

7. The furniture device of claim 3 further comprising said non-marring layer being one of felt, soft fiber, loop material, and nylon.

8. The furniture device of claim 3 further comprising:
said longitudinal edges and said lateral edges each joining tightly to said plate wherein said device is adapted to prevent litter entering between said longitudinal edges and said lateral edges and said plate.

9. The furniture device of claim 8 further comprising:
adhesive joining said longitudinal edges and said lateral edges to said plate;
a bead of caulk interiorly of said longitudinal edges joining to said plate, interiorly of said lateral edges joining to said plate, and interiorly of said longitudinal edges abutting said lateral edges; and,
said bead of caulk being within said liner, said longitudinal edges and said lateral edges.

10. The furniture device of claim 2 wherein said longitudinal edges, said lateral edges, and said plate form said base as a single piece.

11. A furniture device for containing litter, comprising:
a generally rectangular, water impervious base, said base having a plate and four spaced apart upright edges upon said plate, said plate and said upright edges being of single piece construction, a tread material upon a portion of said plate, and at least one strip of releasable fastener upon said plate opposite said edges;
a generally planar rectangular lid, said lid fitting upon said four upright edges, said lid having a top surface and an opposite non-marring layer, and at least one strip of releasable fastener upon said top surface;
said upright edges extending around said plate forming a perimeter, said upright edges being mutually perpendicular to said plate, said upright edges including two mutually parallel and spaced apart lateral edges and two mutually parallel and spaced apart longitudinal edges said longitudinal edges being perpendicular to said lateral edges;
wherein said device has an open configuration with said lid positioned beneath said base flush with said plate and said at least one strip of releasable fastener of said top surface engaging said at least one strip of releasable fastener of said base and said non-marring layer positioned away from said base; and,
wherein said device has a closed configuration with said lid secured to said edges with mechanical fasteners, said top surface of said lid being outwardly from said edges, and said lid being flush with said upright edges.

12. The furniture device of claim 11 further comprising:
a handle extending outwardly from one of said longitudinal edges;
a holder releasably connecting to one of said longitudinal edges, said holder adapted to receive hand tools and supplies for pet care; and,
a ramp having its height proportional to that of a lateral edge, a portion of tread material, and at least one strip of releasable fastener opposite the tread material.

13. The furniture device of claim 11 further comprising said non-marring layer being one of felt, soft fiber, loop material, and nylon.

14. The furniture device of claim 11 further comprising:
said lid having four corners and at least one aperture proximate each corner, at least one mechanical fastener for each of said at least one aperture, and two strips of releasable fastener upon said top surface, said strips being mutually parallel and spaced apart.

15. The furniture device of claim 11 further comprising:
said upright edges including two mutually parallel and spaced apart lateral edges and two mutually parallel and spaced apart longitudinal edges, said longitudinal edges being perpendicular to said lateral edges;
said lid fitting upon said lateral edges and said longitudinal edges opposite said plate when said device attains its closed configuration;
said lid having four corners and at least one aperture proximate each corner, at least one mechanical fastener for each of said at least one aperture, and two strips of releasable fastener upon said top surface, said strips being mutually parallel and spaced apart; and,
said plate having two strips of said releasable fastener, said strips of said plate being in registration with said strips of said lid wherein said strips of said lid engage said strips of said plate in the open configuration of said device.

16. The furniture device of claim 11 further comprising:
each of said longitudinal edges merging with both of said lateral edges defining two spaced apart corners, said device thus having four corners;
said corners being continuous; and,
said longitudinal edges and said lateral edges extending continuously upward from said plate.

17. The furniture device of claim 15 wherein said lid connects to said base in the closed configuration of said device and is adapted to prevent litter escaping from said device.

18. The furniture device of claim 15 wherein said base is adapted to prevent litter escaping from said base.

19. A furniture device for containing litter, comprising:
a base, generally rectangular, having a plate and four spaced apart upright edges upon said plate, a water impervious liner interiorly of said upright edges and said plate, a tread material upon a portion of said liner, and at least one strip of releasable fastener upon said plate opposite said edges;
a lid, generally a planar rectangle, said lid fitting upon said four upright edges, said lid having a top surface and an opposite non-marring layer, and at least one strip of releasable fastener upon said top surface;
wherein said device has an open configuration with said lid positioned beneath said base flush with said plate and said at least one strip of releasable fastener of said top surface engaging said at least one strip of releasable fastener of said base and said non-marring layer positioned away from said base;
wherein said device has a closed configuration with said lid secured to said edges with mechanical fasteners, said top surface of said lid being outwardly from said edges, and said lid being flush with said upright edges;
said plate having a perimeter and said upright edges securing to that perimeter;
said upright edges being mutually perpendicular to said plate, said upright edges including two mutually parallel and spaced apart lateral edges and two mutually parallel and spaced apart longitudinal edges said longitudinal edges being perpendicular to said lateral edges; said lid fitting upon said lateral edges and said longitudinal edges opposite said plate when in said closed configuration;
a handle extending outwardly from one of said longitudinal edges;
a holder releasably connecting to one of said longitudinal edges, said holder adapted to receive hand tools and supplies for pet care;
a ramp having its height proportional to that of a lateral edge, a portion of tread material, and at least one strip of releasable fastener opposite the tread material;
said lid having four corners and at least one aperture proximate each corner, at least one mechanical fastener for each of said at least one aperture, and two strips of releasable fastener upon said top surface, said strips being mutually parallel and spaced apart, said lid having two depressions extending perpendicularly into said non-marring layer and locating mutually diagonally;
at least one lateral edge extender and at least one longitudinal edge extender;
said at least one lateral edge extender having a releasable mechanical connection to one of said lateral edges opposite said plate and said at least one lateral edge extender being coplanar with said lateral edge;
said at least one longitudinal edge extender having a releasable mechanical connection to one of said longitudinal edges opposite said plate and said at least one longitudinal edge extender being coplanar with said longitudinal edge;
wherein a longitudinal edge extender mechanically connects to an adjacent lateral edge extender;
wherein said at least one lateral edge extender and said at least one longitudinal edge extender cooperate with said base to increase litter retained within said base;
at least one boss upon at least one of said longitudinal edges, wherein said at least one boss aligns and enters one of said depressions when said device attains the closed configuration as said lid aligns with said upright edges;
said non-marring layer being one of felt, soft fiber, loop material, and nylon;
said longitudinal edges and said lateral edges each joining tightly to said plate wherein said device is adapted to prevent litter entering between said longitudinal edges and said lateral edges and said plate;
adhesive joining said longitudinal edges and said lateral edges to said plate;
a bead of caulk interiorly of said longitudinal edges joining to said plate, interiorly of said lateral edges joining to said plate, and interiorly of said longitudinal edges abutting said lateral edges; and,
said bead of caulk being within said liner, said longitudinal edges and said lateral edges.

20. The furniture device of claim 19 wherein said longitudinal edges, said lateral edges, and said plate form said base as a single piece.
